(19) United States
(12) Patent Application Publication
(10) Pub. No.: US 2015/0120784 A1
(43) Pub. Date: Apr. 30, 2015

(54) INFORMATION MANAGEMENT SYSTEM AND INFORMATION MANAGEMENT METHOD

(71) Applicant: Jun SATOH, Tokyo (JP)

(72) Inventor: Jun SATOH, Tokyo (JP)

(73) Assignee: RICOH COMPANY, LTD., Tokyo (JP)

(21) Appl. No.: 14/521,628

(22) Filed: Oct. 23, 2014

(30) Foreign Application Priority Data
Oct. 28, 2013 (JP) 2013-222894
Oct. 22, 2014 (JP) 2014-215342

(51) Int. Cl. G06F 17/30

(52) U.S. Cl. CPC G06F 17/30286
USPC 707/802

(57) ABSTRACT

An information management system including a unit that generates a first user identification information of first and second user identification information having different authority and stores organization identification information in association with the first and second user identification information in response to a request to register an organization that uses a service provided via a network, a storage unit, upon receiving the organization identification information, device identification information, and the first or the second user identification information, stores the device identification information in association with the organization identification information in a case where the received first or the second user identification information is stored in association with the organization identification information, and a license information storage unit, upon receiving the device identification information and license identification information, stores the license identification information in association with the device identification information.

### BACKGROUND OF THE INVENTION

1. Field of the Invention

The present invention relates to an information management system and an information management method.

2. Description of the Related Art

Conventionally, a service provided through a network, such as a cloud service, can be used by various types of devices.

One advantage of the cloud service is that, a user can receive a cloud service with consistency even in a case where the cloud service is used by different devices of the user. For example, after using a cloud service from a PC at the user's workplace, the user can access the cloud service from the user's PC (Personal Computer) at home and receive the cloud service in a state maintaining the continuity of the PC at the user's workplace.

In some cases, however, the user may wish to limit the devices that can access the cloud service. That is, the user may wish to limit access to the cloud service to a certain device, so that the cloud service is allowed to that certain device. In this case, one way to identify the device(s) allowed with access to the cloud service is to associate the cloud service with device information beforehand and manage the device information.

It is difficult to manage, for example, the use of the cloud service in units of organizations (e.g., units of companies) by merely associating devices with the cloud service.

This problem is not limited to the cloud service but is also common for a service provided by a ASP (Application Service Provider) or a service provided via a network (e.g., Web service).

### Patent Document 1: Japanese Laid-Open Patent Publication No.: 2011-096155

### SUMMARY OF THE INVENTION

The present invention may provide an information management system and an information management method that substantially obviate one or more of the problems caused by the limitations and disadvantages of the related art.

Features and advantages of the present invention are set forth in the description which follows, and in part will become apparent from the description and the accompanying drawings, or may be learned by practice of the invention according to the teachings provided in the description. Objects as well as other features and advantages of the present invention will be realized and attained by an information management system and an information management method particularly pointed out in the specification in such full, clear, concise, and exact terms as to enable a person having ordinary skill in the art to practice the invention.

To achieve these and other advantages and in accordance with the purpose of the invention, as embodied and broadly described herein, an embodiment of the present invention provides an information management system including a user information generation unit that generates a first user identification information of a first user and a second user identification information of a second user having a second authority different from a first authority of the first user and stores organization identification information in association with the first and second user identification information in response to a request to register an organization that uses a service provided via a network, a device information storage unit, upon receiving the organization identification information, device identification information identifying a device connected to the network, and the first or the second user identification information, stores the device identification information in association with the organization identification information in a case where the received first or the second user identification information is stored in association with the organization identification information, and a license information storage unit, upon receiving the device identification information and license identification information identifying a license corresponding to the service, stores the license identification information in association with the device identification information.

Other objects, features and advantages of the present invention will become more apparent from the following detailed description when read in conjunction with the accompanying drawings.

### BRIEF DESCRIPTION OF THE DRAWINGS

FIG. 1 is a schematic diagram illustrating a first example of a configuration of an information management system according to an embodiment of the present invention;

FIG. 2 is a schematic diagram illustrating a hardware configuration of a service providing device according to an embodiment of the present invention;

FIG. 3 is a schematic diagram illustrating a hardware configuration of a device according to an embodiment of the present invention;

FIG. 4 is a schematic diagram illustrating a functional configuration of the service providing device according to an embodiment of the present invention;

FIG. 5 is a schematic diagram illustrating a functional configuration of a device according to an embodiment of the present invention;

FIG. 6 is a sequence diagram for describing a sequence of processes executed in accordance with the selling of a license of a device cooperation service;

FIG. 7 is a schematic diagram illustrating a configuration of a tenant information storage unit;

FIG. 8 is a schematic diagram illustrating a configuration of a user information storage unit;

FIG. 9 is a schematic diagram illustrating a configuration of a license information storage unit;

FIG. 10 is a sequence diagram for describing a first example of a sequence of processes executed when the use of a license is started;

FIG. 11 is a schematic diagram illustrating a configuration of an authority information storage unit;

FIG. 12 is a schematic diagram illustrating a configuration of a device information storage unit;

FIG. 13 is a sequence diagram for describing a second example of a sequence of processes executed when the use of a license is started;

FIG. 14 is a schematic diagram illustrating an example where a device activation screen is displayed;

FIG. 15 is a sequence diagram for describing a sequence of processes executed for adding a regular user;

FIG. 16 is a sequence diagram for describing a sequence of processes executed when utilizing management information;

FIG. 17 is a schematic diagram for describing a first example of a license information search result;

FIG. 18 is a schematic diagram for describing a second example of a license information search result; and

FIG. 19 is a schematic diagram illustrating a second example of a configuration of an information management system according to an embodiment of the present invention.

### DETAILED DESCRIPTION OF THE PREFERRED EMBODIMENTS

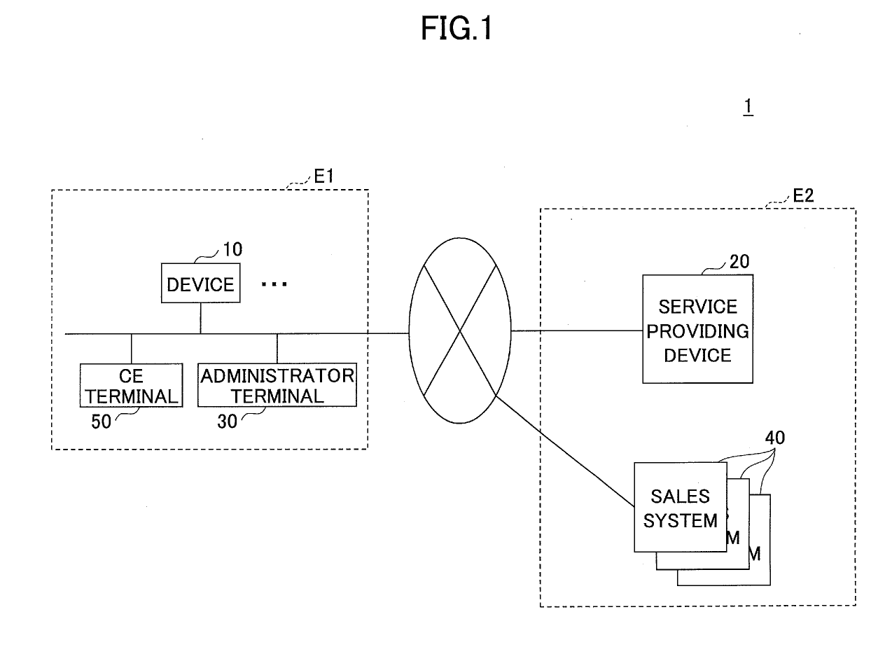

Embodiments of the present invention are described with the accompanying drawings. FIG. 1 is a schematic diagram illustrating a first example of a configuration of an information management system 1 according to an embodiment of the present invention.

The information management system 1 of FIG. 1 includes, for example, a user environment E1 and a service providing environment E2 that can communicate with each other via a wide area network such as the Internet.

The service providing environment E2 is a system environment of an organization that provides a cloud service via a network. Although this embodiment is described with an example of a cloud service, this embodiment may be applied to other services provided via a network such as a service provided via an ASP (Application Service Provider) or a Web service.

The service providing system E2 includes, for example, a service providing device 20 and one or more sales systems 40. The service providing device 20 provides a predetermined service via a network. Particularly, the service providing device 20 provides a service that cooperates with a device 10 included in the user environment E1. The service that cooperates with the device 10 is a service that is implemented by using a function of the device 10. Each of the various services provided by the service providing device 20 may be hereinafter collectively referred to as a “device cooperation service”. Further, the service providing device 20 also manages a license pertaining to the device cooperation service. A license may be, for example, authorization to use the device cooperation service.

It is, however, to be noted that the service providing apparatus 20 may be physically placed in the user environment E1.

Each sales system 40 includes one or more computers that are installed in correspondence with the sales locations of the device cooperation service. The sales locations are provided in correspondence with the sales areas of the device cooperation service. For example, at the sales location, a license of the device service cooperation service are sold to a user of the user environment E1 that belongs to a corresponding sales area. For example, the contents of the license that has been sold is input to the sales system 40. The sales area may be divided into, for example, U.S.A, Europe, Japan, and Asia (excluding Japan).

The user environment E1 is a system environment of an organization (e.g., company) to which the user of the device 10 belongs. The user environment E1 includes, for example, one or more devices 10, an administrator terminal 30, and a CE terminal 50 that are connected to each other via a network (e.g., LAN (Local Area Network)).

The device 10 is a terminal that is used by a user administrator of the user environment E1. The user administrator is a user who is given special authorization (authority) pertaining to operating one or more functions of the device cooperation service.

The CE terminal 50 is a terminal that is used by a customer engineer (CE) of the user environment E1. The customer engineer is, for example, a person that visits the user environment E1 and performs maintenance and the like on the device 10. The CE terminal 50 need not be constantly connected to the network of the user environment E1. For example, the CE terminal 50 carried by the customer engineer may be connected to the network of the user environment when the customer engineer visits the user environment E1. The CE terminal 50 may also be connected directly to the device 10.

Examples of the administrator terminal 30 and the CE terminal 50 are PCs, PDAs (Personal Digital Assistant), tablet type terminals, smartphones, and mobile phones.

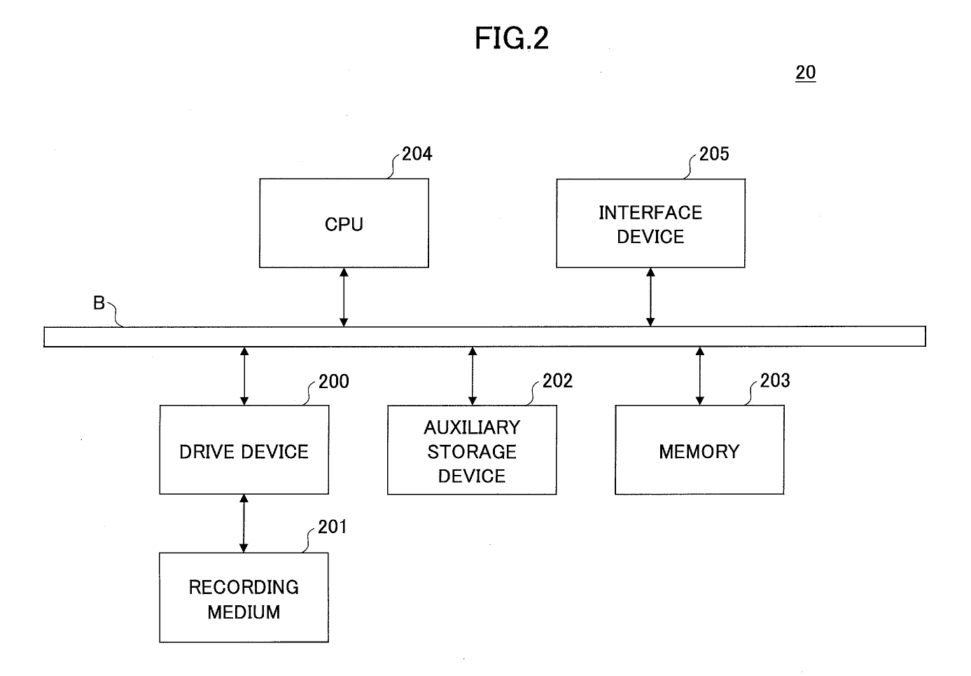

FIG. 2 is a schematic diagram illustrating a hardware configuration of the service providing device 20 according to an embodiment of the present invention. The service providing device 20 of FIG. 2 includes, for example, a drive device 200, an auxiliary storage device 202, a memory 203, a CPU (Central Processing Unit) 204, and an interface device 205 that are connected to each other by a bus B.

A program that implements the processes of the service providing device 20 is provided by a recording medium 201 such as a CD-ROM and the like. When the recording medium 201 having the program recorded thereon is set in the drive device 200, the program is installed from the recording medium 201 to the auxiliary storage device 202 via the drive device 200. However, the program does not necessarily need to be installed from the recording medium 201. For example, the program may be downloaded from another computer via a network. The auxiliary storage device 202 stores, for example, the installed program along with other necessary files and data.

In a case where activation of the program is instructed, the memory 203 reads out the program from the auxiliary storage device 202 and stores the program therein. The CPU 204 executes the functions of the service providing device 20 according to the program stored in the memory 203. The interface device 205 is used as an interface for connecting with a network.

It is to be noted that the service providing device 20 may be constituted by multiple computers in which each computer has the hardware configuration illustrated in FIG. 2. That is, the processes performed by the service providing device 20 may be distributed to and executed by multiple computers.

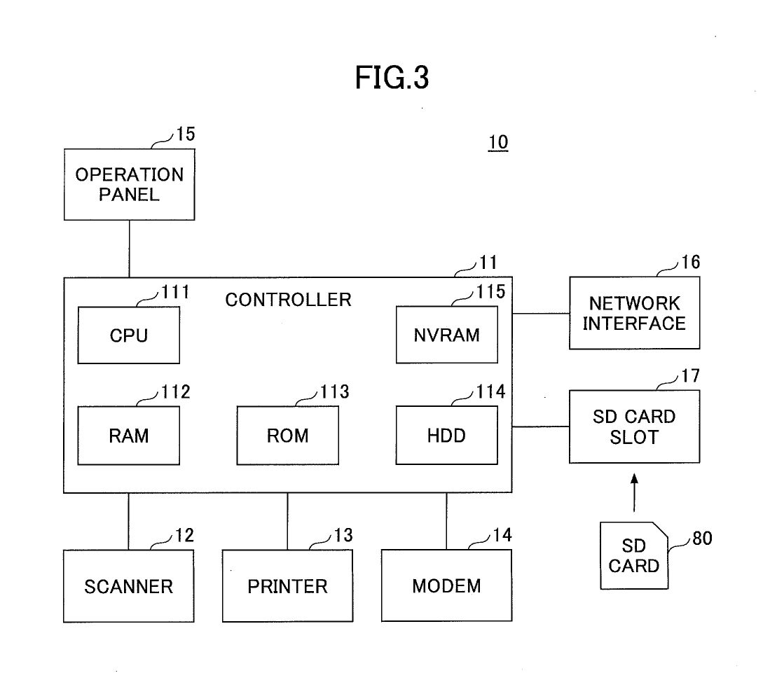

FIG. 3 is a schematic diagram illustrating a hardware configuration of the device 10 according to an embodiment of the present invention. The device 10 illustrated in FIG. 3 is an image forming apparatus that includes hardware such as a controller 11, a scanner 12, a printer 13, a modem 14, an operation panel 15, a network interface 16, and an SD card slot 17.

The controller 11 includes, for example, a CPU 111, a RAM (Random Access Memory) 112, a ROM (Read-Only Memory) 113, a HDD (Hard Disk Drive) 114, and a NVRAM (Non-Volatile RAM) 115. Various programs and data used by the programs are stored in the ROM 113. The RAM 112 is used as a storage space in to which a program is loaded and as a workspace of the loaded program. The CPU 111 executes various functions of the device 10 by processing the program loaded in the RAM 112. For example, programs and various data used by the programs may be stored in the HDD 114. For example, various setting information such as setting information of the device 10 may be stored in the NVRAM 115.

The scanner 12 is hardware (image reading unit) for reading image data from a manuscript or the like. The printer is hardware (printing unit) for printing print data on paper or the like. The modem 14 is hardware for connecting to a telephone line and is used for transmitting/receiving image data by facsimile communications. The operation panel 15 is hardware that includes an input unit such as buttons for receiving input by the user and a display unit such as a liquid crystal display panel. The liquid crystal display panel may have a function of a touch panel. In this case, the liquid crystal display panel also serves as the input unit. The network interface 16 is hardware for connecting to a network (regardless of whether the network is wired or wireless connected) such as a LAN. The SD card slot 17 is used for reading a program stored in an SD card 80. That is, the device 10 not only can execute programs stored in the ROM 113 but can also execute programs loaded to the RAM 112 from the SD card 80. It is, however, to be noted that the SD card 80 may be replaced with other recording media (e.g., CD-ROM, USB (Universal Serial Bus)). That is, the type of recording medium is not limited to that of the SD card 80. Thus, in a case where the SD card 80 is substituted for another type of recording medium, the card slot 17 may be replaced by hardware corresponding to the type of the substituting recording medium.

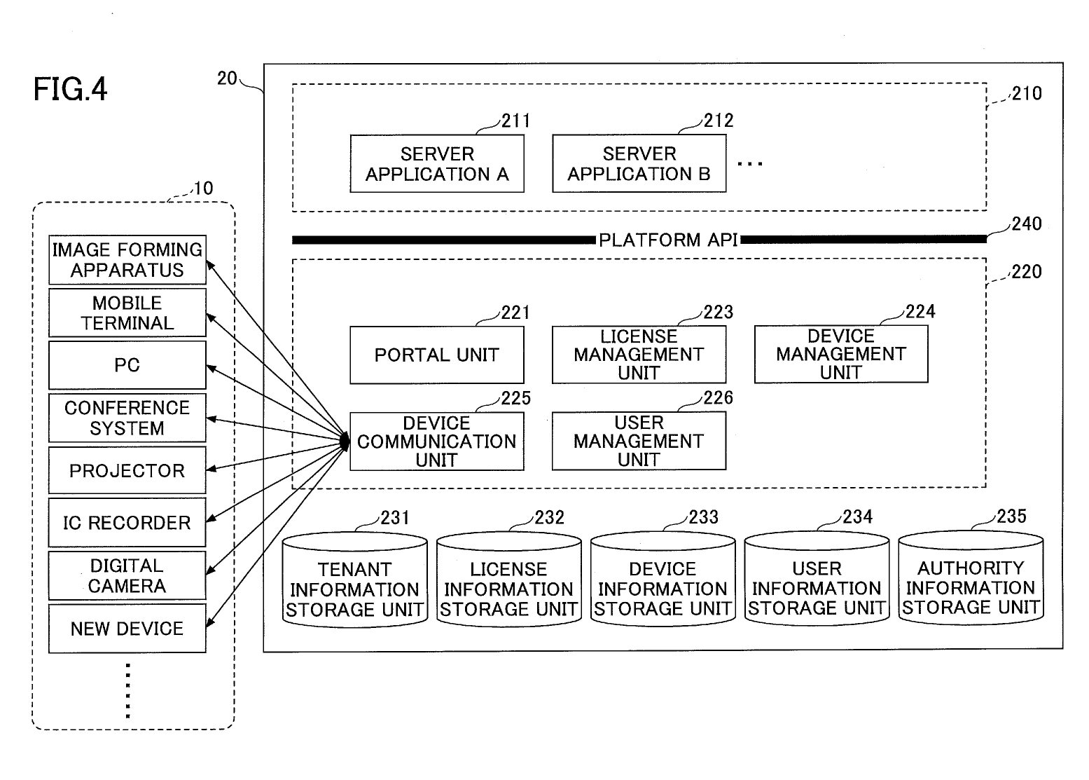

FIG. 4 is a schematic diagram illustrating a functional configuration of the service providing device 20 according to an embodiment of the present invention. The service providing device 20 of FIG. 4 includes software such as a server application 210 and a platform 220. The functions of the software included in the service providing device 20 are implemented by executing processes with the CPU 204 in accordance with one or more programs installed in the service providing device 20.

The service providing device 20 also includes, for example, a tenant information storage unit 231, a license information storage unit 232, a device information storage unit 233, a user information storage unit 234, and an authority information storage unit 235. These storage units 231-235 may be implemented by, for example, the auxiliary storage device 202 or a storage device connected to the service providing device 20 via a network.

The server application 210 is an application program of the server side (cloud service side) for implementing a device cooperation service. Each server application 210 implements a single (one type) device cooperation service. In the embodiment of FIG. 4, a server application “A” 211 and a server application “B” 212 are examples of the server application 210. In this embodiment, the functions of the server applications “A” 211, “B” 212 are not limited to a particular function. For example, the server application “A” 211 may have a function to distribute (transmit) image data scanned by the device 10 to an online storage that is designated beforehand as a distribution destination.

The platform 220 may have a function that is common among multiple server applications 210 or a basic function that is used by multiple server applications 210. In FIG. 4, the platform 220 includes, for example, a portal unit 221, a license management unit 223, a device management unit 224, a device communication unit 225, and a user management unit 226. The functions of these units 221-226 are disclosed to the server application 210 through a platform API 240. That is, the server application 210 can use the functions of these units 221-226 to the extent that is made available by the platform API 240.

The portal unit 221 provides a portal site of the service providing device 20. The license management unit 223 executes a process for managing the license of each device cooperation service. It is to be noted that the server application 210 and the device cooperation service correspond to each other on a one-on-one basis. Therefore, the license of one device cooperation service is equivalent to the license of the server application 210 corresponding to the one device cooperation service. The device management unit 224 executes a process for managing information that is stored in the device information storage unit 233. The device communication unit 225 performs communications with the device 10. The user management unit 226 executes a process pertaining to user management of the device cooperation service.

In the embodiment of FIG. 4, other than the image forming apparatus, the device 10 may also be, for example, a mobile terminal, a PC, a conference system, an image projector, an IC recorder, a digital camera, or a new device.

The tenant information storage unit 231 stores information pertaining to a tenant. In this embodiment, the term “tenant” refers to an organization (contract organization) that has purchased the license of the device cooperation service (concluded a contract for use of the license). For example, one company may be one tenant. Alternatively, one belonging to one company may be one tenant. That is, one company may include multiple tenants. In this embodiment, one user environment E1 may be one tenant. In any of these cases, the tenant is a set (aggregate) of one or more individual users that actually use the device cooperation service. Further, the organization is not limited to an organization related to a company. That is, the organization may be, for example, a given group or coterie. Further, the organization may be constituted by a single person.

The license information storage unit 232 stores information pertaining to the license of the device cooperation service used by each tenant. The device information storage unit 233 stores information pertaining to the device 10 of each tenant. The user information storage unit 234 stores information pertaining to the user of the device cooperation service. The authority information storage unit 235 stores information indicating an operation of a function of the device cooperation service that can be executed according to the role of the user. The authority information storage unit 235 stores such information in correspondence with the role of the user. The role of the user is described in further detail below.

The manner in which each software application and each storage unit illustrated in FIG. 4 are classified (categorized) is merely an example. The software and storage units constituting the service providing device 20 need not be hierarchically classified as illustrated in FIG. 4. That is, as long as the device 10 can be cooperatively used with the server application 210, the hierarchical relationship and the like of the software and storage units of the service providing device 20 is not to be limited in particular.

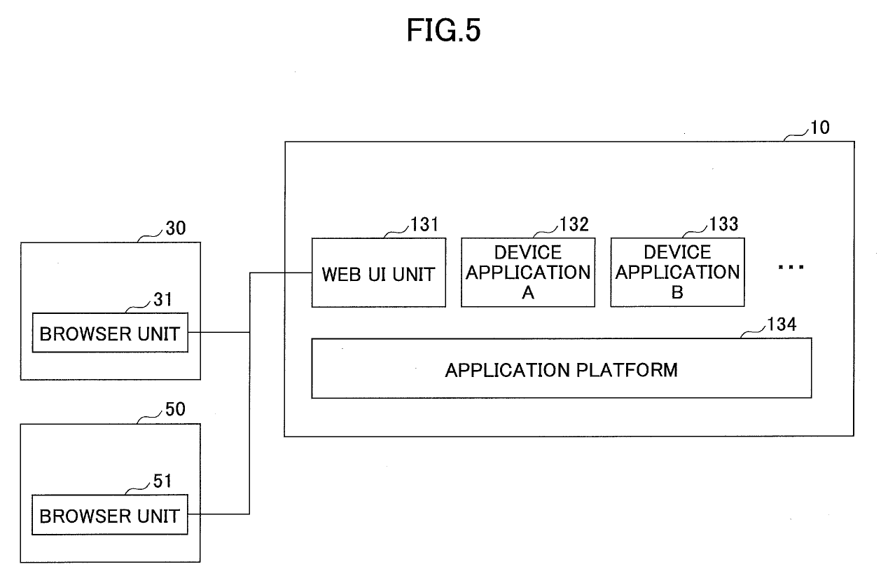

FIG. 5 is a schematic diagram illustrating a functional configuration of the device 10 according to an embodiment of the present invention. The device 10 of FIG. 5 includes a Web UI unit 131, a device application “A” 132, a device application “B” 133, and an application platform 134. Each of the units 131-134 included in the device 10 are implemented by executing processes with the CPU 111 in accordance with one or more programs installed in the device 10.

The Web UI unit 131 provides a user interface through a Web page via a network. In this embodiment, the Web UI unit 131 provides the user interface through a Web page for the administrator terminal 30 or the CE terminal 50.

The device application “A” 132 and the device application “B” 133 are examples of application programs installed in the device 10 for implementing the device cooperation service. For example, the device application “A” 132 may form a pair with the server application “A” 211. By cooperating with the server application “A” 211, the device application “A” 132 implements a single device cooperation service. For example, the function of the device application “A” 132 may be to instruct the device 10 to scan a manuscript and transfer image data of the scanned manuscript to the server application “A” 211. For example, the device application “B” 133 may form a pair with the server application “B” 212. By cooperating with the server application “B” 212, the device application “B” 133 implements a single device cooperation service.

The application platform 134 implements an execution environment for executing, for example, the Web UI unit 131, the device application “A” 132, and the device application “B” 133.

In the embodiment of FIG. 5, the administrator terminal 30 includes a browser unit 31. Further, the CE terminal 50 includes a browser unit 51. For example, the browser units 31, 51 are implemented by executing processes with a CPU included in the administrator terminal 30 or the CE terminal 50 in accordance with a Web browser program. For example, the browser units 31, 51 may display a Web page provided by the Web UI unit 131 and execute processes in response to input to the Web page.

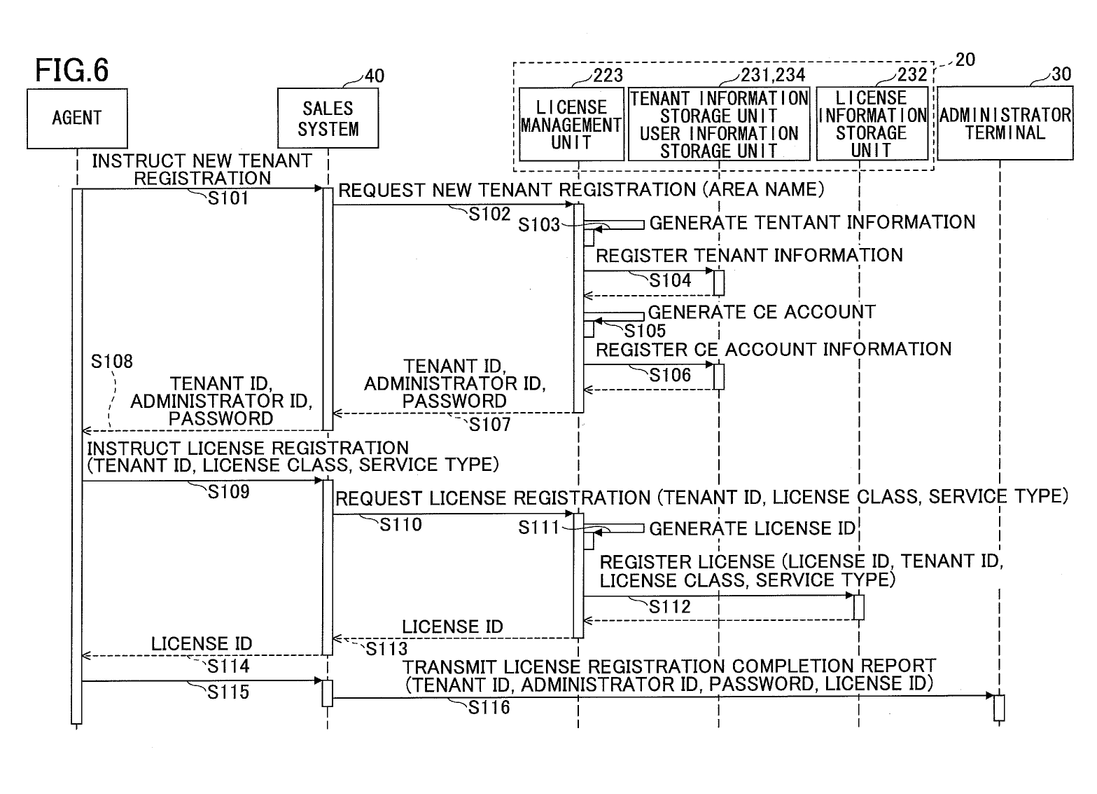

Next, a sequence (procedure) of processes executed by the information management system 1 according to an embodiment of the present invention is described. FIG. 6 is a sequence diagram for describing a sequence of processes executed in accordance with the selling of a license of a device cooperation service. As a premise of the processes of FIG. 6, it is assumed that a certain license of a certain device cooperation service is sold to the user environment E1 at a certain sales location, and the user environment E1 belongs to a sales area that is assigned to the certain sales location. The embodiment of FIG. 6 illustrates processes for registering information pertaining to the sold license to the service providing device 20 in response to input to the sales system 40 by an agent (assignee). The user environment E1 that has purchased the license is hereinafter also referred to as “target tenant”. In FIG. 6, the “agent” is an entity that has received (been assigned) a subscription for tenant registration by the target tenant. Alternatively, the “agent” may be a user administrator of the target tenant or a customer engineer that is visiting the target tenant.

In a case where the target tenant is a new tenant, processes of Steps S101-S108 are executed for registering the target tenant as a tenant. The “new tenant” is a user that has purchased a license of a device cooperation service for the first time. Therefore, in a case of a user that has purchased a license of one device cooperation service and is already registered as a tenant, the processes of Steps S101-S108 need not be executed in a case where the user purchases a license of another device cooperation service.

In Step S101, the agent inputs an instruction to register the target tenant as a new tenant to the sales system 40. Then, the sales system 40 transmits a new tenant, registration request to the license management unit 223 of the service providing device 20 (Step S102). The registration request includes, for example, a designation of an area name of a sales area to which the sales system 40 belongs. The license management unit 223 generates, for example, a tenant ID corresponding to the target tenant along with a user ID and a password of the user administrator of the target tenant in response to the registration request (Step S103). The tenant ID is identification information corresponding to each tenant. It is to be noted that the user administrator is not limited to a person of a particular position in the user environment E1. Further, the user administrator is not limited to a particular individual. For example, permission to use the same administrator ID and password may be granted to multiple persons. The user ID of the user administrator is also hereinafter referred to as “administrator ID”. Further, the password of the user administrator is also hereinafter referred to as “administrator password”.

Then, the license management unit 223 registers a record of the target tenant in the tenant information storage unit 231 (Step S104).

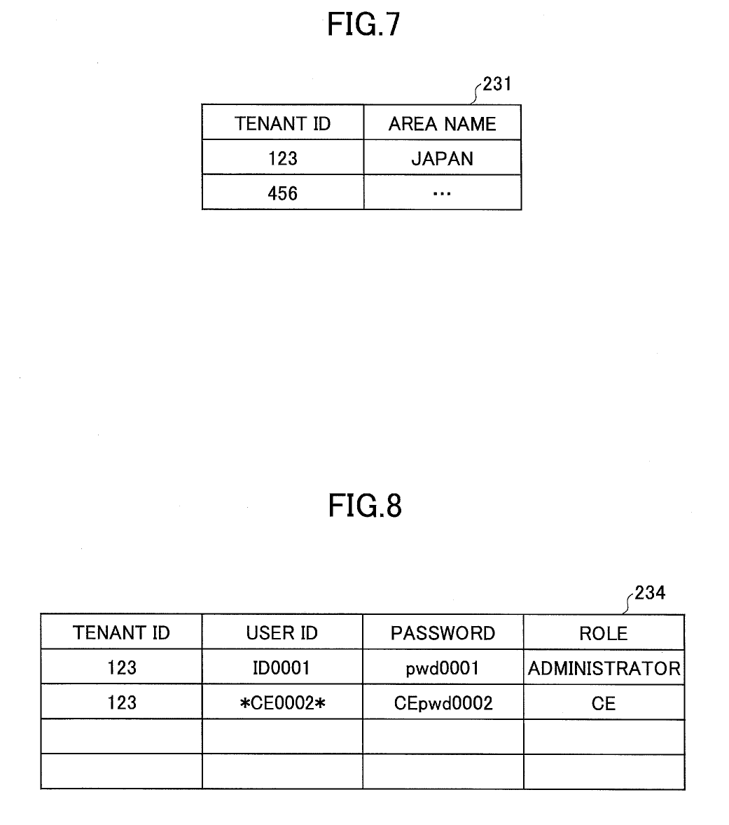

FIG. 7 is a schematic diagram illustrating a configuration of the tenant information storage unit 231. In FIG. 7, the tenant information storage unit 231 registers tenant information in correspondence with each tenant. The tenant information includes, for example, a tenant ID and an area name.

In Step S104, a new record is added to the tenant information storage unit 231 and a value of each item of tenant information is registered in the new record. A value generated by the license management unit 223 in Step S103 is registered as the tenant ID in the tenant information storage unit 231. A value transferred from the sales system 40 is registered as the area name in the tenant information storage unit 231.

In Step S104, the user information pertaining to the user administrator of the target tenant is stored in the user information storage unit 234.

FIG. 8 is a schematic diagram illustrating a configuration of the user information storage unit 234. In FIG. 8, the user information storage unit 234 registers, for example, a tenant ID, a user ID, a password, and a role in correspondence with each user.

The user ID is identification information corresponding to each user. The password is a user's password that is required when logging in to the device cooperation service. The role is a concept for distinguishing or categorizing an operation authority assigned to the user. The operation authority is an authority for performing an operation pertaining to a function of the device cooperation service. In this embodiment, the role of the user can be selected from 3 values (choices) “administrator”, “regular”, and “CE”. The value “administrator” is a role corresponding to the user administrator. The value “user” is a role corresponding to a regular user. The regular user is a user among the users of the tenant except for the user administrator. The operation authority of the regular user is limited compared to the operation authority assigned to the user administrator. The value “CE” is a role corresponding to the customer engineer. As described below, the customer engineer is also registered as a user in the user information storage unit 234. The operation authority of the customer engineer is limited compared to the operation authority assigned to the user administrator. For example, the operation authority of the customer engineer may be limited, so that the customer engineer can only perform an operation that is required during the start of use of the license of the device cooperation service.

In Step S104, a new record having a value “administrator” is added to the user information storage unit 234, and an administrator ID and a password generated in Steps S103 are registered in the corresponding items “user ID” and “password” in the record newly added to the user information storage unit 234. For example, the first record illustrated in FIG. 8 is an example of the record that is added in Step S104. Alternatively, the administrator ID and the administrator password may be designated by the target tenant at the time of selling the license to the target tenant. In this case, the agent may input the designated administrator ID and the administrator password to the sales system 40 in Step S101.

Then, the license management unit 223 generates a CE account (Step S105). The CE account is an account to be used for a customer engineer. The CE account includes information such as a user ID and password of the customer engineer. The CE account (including user ID and password) may be randomly generated. Alternatively, the CE account may be a fixed value that is determined beforehand. Further, the CE account may differ with respect to each tenant. Alternatively, the CE account may be shared by all tenants. In a case where the CE account is shared by all tenants, the customer engineer may conveniently attain the benefit of performing an operation for multiple tenants by using a single user ID and password.

Then, the license management unit 223 stores (adds) the generated CE account in the user information storage unit 234 (Step S106). For example, the second record illustrated in FIG. 8 is an example of the record that is added in Step S106. That is, the value of the record registered in the CE account is “CE”. Similar to the user administrator or the regular user, the CE account is stored in correspondence with the tenant ID in the user information storage unit 234. That is, the customer engineer is also virtually stored as a user belonging to the tenant in the user information storage unit 234.

Then, the license management unit 223 returns (transmits) the tenant ID, the administrator ID, and the administrator password corresponding to the target tenant to the sales system 40 (Step S107). Then, the sales system 40 outputs the transmitted tenant ID, administrator ID, and administrator password (Step S108). The sales system 40 may output the transmitted information (tenant ID, administrator ID, and administrator password) in the form of, for example, displaying the transmitted information on a display device or printing the transmitted information with a printer.

Then, the agent inputs an instruction to register information pertaining to the license that has been sold to the target tenant (new license) (Step S109). Along with the registration instruction, the agent also inputs, for example, a tenant ID of the target tenant, a license class, and a service type. The “license class” is a class of the range of authority assigned to a license for using the device cooperation service. For example, the license class may be defined in accordance with the range of the function that can be used. Further, the billing cost (charging cost) may differ depending on the license class. The “service type” is a type of device cooperation service that is the object of the license. The license class and the service type are determined according to the desire of the target tenant at the time of selling a new license to the target tenant.

Then, the sales system 40 transmits a new license registration request to the license management unit 223 (Step S110). The registration request includes, for example, a designation of the input tenant ID, license class, and service type. The license management unit 223 generates, for example, a license ID corresponding to the license of the license registration request in response to the license registration request (Step S111). The license ID is identification information corresponding to each license. Then, the license management unit 223 registers a record of the new license to the license information storage unit 232 (Step S112).

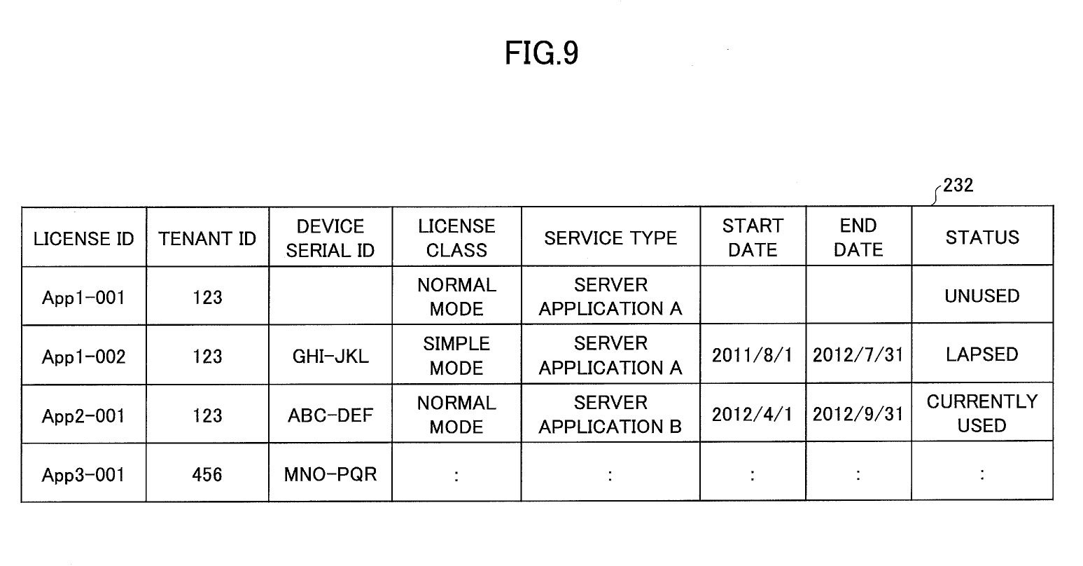

FIG. 9 is a schematic diagram illustrating a configuration of the license information storage unit 232. In FIG. 9, the license information storage unit 232 includes, for example, a license ID, a tenant ID, a device serial ID, a license class, a license type, a start date, an end date, and a status that corresponds with each license.

The “license ID” indicates an ID corresponding to a license. The “tenant ID” indicates an ID of a tenant assigned with a license. The “device serial ID” indicates identification information assigned to each device that is to be used for the device cooperation service of a license. A manufacture number, a MAC address or an IP address are examples of the “device serial ID”. The “license class” indicates a class of a license. The “service type” indicates a type of device cooperation service of a license. In this embodiment, the name of the server application 210 is the value of the “service type”. The “start date” indicates a date of the start of use of a license. The “end date” indicates a date of the end of use of a license. The “use of a license” includes using a device cooperation service of a license in the user environment E1. The “status” indicates a status of a license. In this embodiment, the status of a license includes “unused”, “currently used”, and “lapsed”. The status “unused” indicates a state where the use of a license has not started. The status “currently used” indicates a state where the use of a license has started. The status “lapsed” indicates a state where the use of a license has ended (i.e. expiration of the term of use of the license).

In Step S112, a new record is added to the license information storage unit 232, and the values of “license ID”, “tenant ID”, “license class”, “service type”, and “status” are stored in correspondence with the new record in the license information storage unit 232. For example, the record of the first row in FIG. 9 corresponds to the record registered in Step S112. The value generated in Step S111 is stored in “license ID”. The values transferred from the sales system 40 are stored in “tenant ID, “license class”, and “service type”, respectively. The value “unused” is stored in “status”.

Then, the license management unit 223 returns (transmits) the license ID of the new license to the sales system 40 (Step S113). Then, the sales system 40 outputs the transmitted license ID (Step S114). The sales system 40 may output the transmitted license ID in the form of, for example, displaying the license ID on a display device or printing the license with a printer.

Then, the agent inputs an instruction to the sales system 40 (Step S115). Then, the sales system 40 transmits a license registration completion notice to the administrator terminal 30 of the target tenant in accordance with the instruction input by the agent (Step S116). The license registration completion notice includes, for example, the tenant ID, the administrator ID, the administrator password, and the license ID of the new license. By transmitting the notice including the tenant ID, the administrator ID, and the administrator password, the user administrator can from hereon know information that is required for logging in on the device cooperation service. The license registration completion notice may be transmitted by, for example, electronic mail. In this case, the agent may receive the destination address for transmitting the electronic mail from the target tenant at the time of selling the license to the target tenant. Further, the process of Step S116 may be automatically executed after, for example, Step S113. In a case where the target tenant is not a new user, the notice including the tenant ID, the management ID, and the administrator password does not necessarily need to be transmitted to the target tenant.

Next, a sequence (procedure) of processes executed when a customer engineer performs an operation for starting the use of a license in the user environment E1 is described.

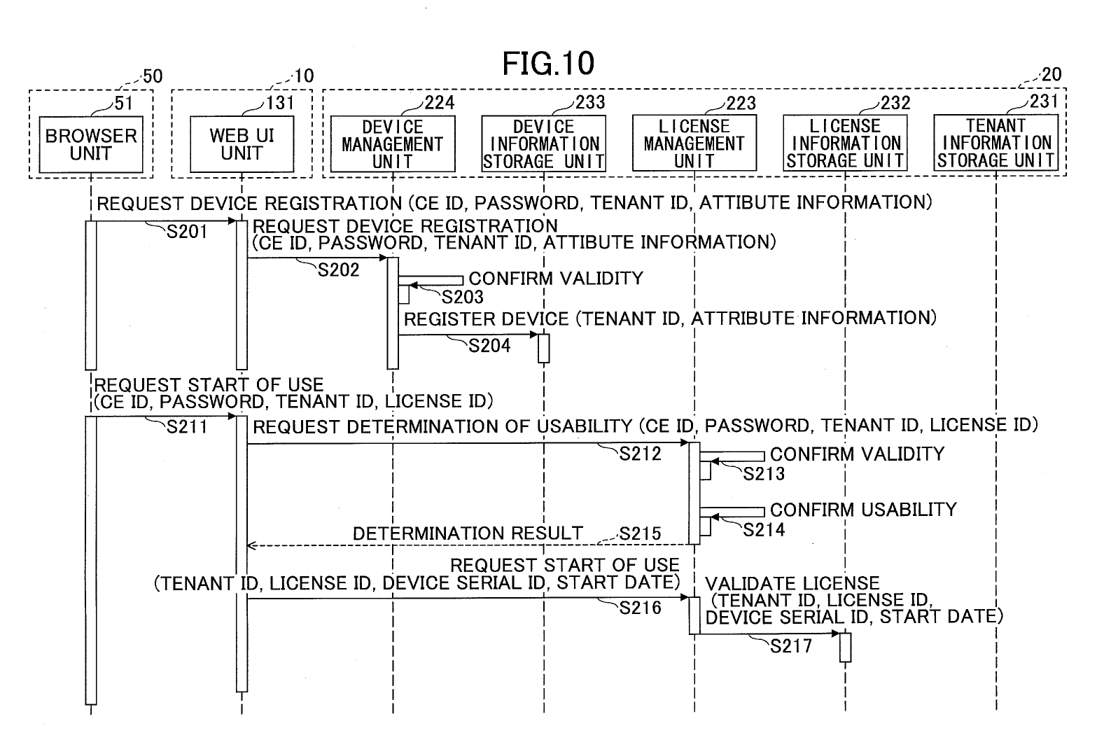

FIG. 10 is a sequence diagram for describing a first example of a sequence of processes executed when the use of a license is started. At the start of the sequence of FIG. 10, it is assumed that a device registration screen is displayed on the CE terminal 50 by the browser unit 51. The browser unit 51 displays the device registration screen based on, for example, a Web page provided by the Web. UI unit 131. Technically, the information transmitted from the device 10 (Web UI 131) is received by the device communication unit 225 (not illustrated in FIG. 10) and transferred (relayed) to the device management unit 224 or the license management unit 223. However, for the sake of convenience, the relay of information by the device communication unit 225 is omitted from FIG. 10.

In a case where the customer engineer inputs, for example, a CE_ID, a CE password, a tenant ID, and attribute information of the device 10 of a registration target by way of the device registration screen, the browser unit 51 transmits a device registration request including designations of the input information to the Web UI unit 131 (Step S201). Then, the Web UI unit 131 transfers the device registration request to the device management unit 224 (Step S202). In a case of transferring the device registration request, the Web UI unit 131 may obtain the device serial ID of the device 10 and include the obtained device serial ID in the attribute information of the device 10. That is, the attribute information input by the customer engineer does not necessarily need to be attribute information that is not stored in the device 10.

Then, the device management unit 224 confirms the validity of the device registration request (Step S203). More specifically, the device management unit 224 determines whether the user information storage unit 234 is stored with a record including a set of the CE_ID, the CE password, and the tenant ID designated in the device registration request. In a case where the user information storage unit 234 is not stored with the record including the set of the designated information, the processes hereafter are canceled. In a case where the user information storage unit 234 is stored with the record including the set of the designated information, the device management unit 224 determines whether device registration is permitted of the “role” of the record by referring to the authority information storage unit 235.

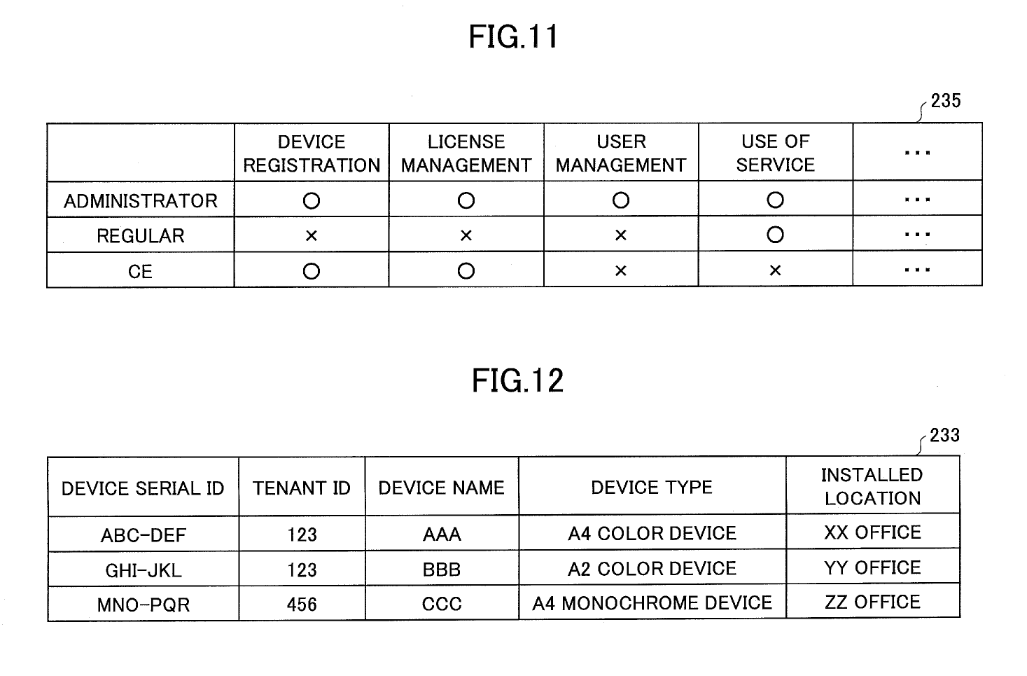

FIG. 11 is a schematic diagram illustrating a configuration of an authority information storage unit 235. In the authority information storage unit 235 of FIG. 11, roles of the user are arranged in rows, and operations pertaining to the function of the device cooperation service are arranged in columns. As a result, permission of each operation (authority of each operation) is indicated in correspondence with each role. In FIG. 11, “◯” indicates that operation is permitted, and “X” indicates that operation is prohibited. In FIG. 11, “device registration”, “license management”, “user management”, and “use of service (service use)” are examples of the operation. The operation “device registration” includes an operation of registering information pertaining to the device 10 that is to cooperate with the device cooperation service. The operation “device registration” is executed in Step S204 of FIG. 10. The operation “license management” includes various operations pertaining to a license such as the start of use of a license. The operation “user management” includes operations such as adding a user account to the user information storage unit 234, updating a user account of the user information storage unit 234, and deleting a user account from the user information storage unit 234. The operation “use of service (service use)” includes an operation pertaining to the use of an original function of the device cooperation service. The original function is a function that the device cooperation service aims to provide. For the sake of convenience, the class of the operation is omitted in FIG. 11. However, permission of each operation (authority of each operation) for each role may also be set in correspondence with, for example, a function or a method constituting the platform API 240.

For example, the user administrator having the role “administrator” is permitted to perform all of the operations. The regular user having the role “regular” is permitted to perform the operation “service use” but prevented from performing management type operations such as “device registration”, “license management”, and “user management”. The customer engineer having the role “CE” is permitted to perform operations “device registration” and “license management” but is prevented from performing operations of “user management” and “service use”.

In Step S203, the device management unit 224 determines whether the operation “device registration” is permitted for the customer engineer having the role “CE”. In a case where device registration is not permitted for the role “CE”, the processes hereafter are canceled. In a case where device registration is permitted for the role “CE”, the device management unit 224 associates the tenant ID and the attribute information designated in the device registration request and stores the associated information in the device information storage unit 233 (Step S204).

FIG. 12 is a schematic diagram illustrating a configuration of the device information storage unit 233. The device information storage unit 233 stores a record corresponding to each registered device 10. Each record includes items such as “tenant ID”, “device serial ID”, “device name”, “device type”, and “installed location”. The device information storage unit 233 retains information of each device 10 in association with an organization. In FIG. 12, “device serial ID”, “device name”, “device type”, and “installed location” are examples of attribute information of the device 10. The “device name” indicates the name of the type or model of the device. The “device type” indicates brief information pertaining to the function of the type of device corresponding to the device name. The “installed location” indicates the location in the user environment E1 in which the device 10 is installed. For example, in a case where the organization operating in the service providing environment E2 is a manufacturer of the device 10, a database having the device name and the device type stored in correspondence with the device serial ID may already be built. In a case where such database is built, the customer engineer need not input the device name and the device type. Instead, the customer engineer can use the device serial ID as a key and obtain the device name and device type from the database.

It is to be noted that, in a case where multiple devices 10 in the user environment E1 are desired to cooperate with the device cooperation service, the processes of Steps S201-S204 may be executed for all of the multiple devices 10 in a batch or separately executed for each of the multiple devices 10.

In a case where the processes of Steps S201-S204 are performed for at least one device 10, the purchased license (new license described with FIG. 6) can be used in the user environment E1. In this case, the processes of Step S211 and after are executed. At the start of Step S211, it is assumed that a license use start screen is displayed on the CE terminal 50 by the browser unit 51. The browser unit 51 displays the license use start screen based on, for example, a Web page provided by the Web UI unit 131.

In a case where the customer engineer inputs, for example, a CE_ID, a CE password, a tenant ID, and a license ID by way of the license use start screen, the browser unit 51 transmits a license use start request including designations of the input information to the Web UI unit 131 (Step S211). Then, the Web UI unit 131 designates the CE_ID, the CE password, the tenant ID, and the license ID included in the license use start request and requests the license management unit 223 to determine whether the license corresponding to the designated license ID can be used (Step S212).

Then, the license management unit 223 confirms the validity of the license use start request (Step S213). More specifically, the license management unit 223 determines whether the user information storage unit 234 has stored a record including a set of the CE_ID, the CE password, and the tenant ID designated in the license use start request. In a case where the user information storage unit 234 has not stored the record including the set of the designated information, the processes hereafter are canceled. In a case where the user information storage unit 234 has stored the record including the set of the designated information, the license management unit 223 determines whether license management is permitted for the “role” of the record by referring to the authority information storage unit 235 (FIG. 11).

In a case where license management is not permitted for the role “CE”, the processes hereafter are canceled. In a case where license management is permitted for the role “CE”, the license management unit 223 determines where the license corresponding to the designated license ID can be used (Step S214). For example, the license can be determined to be usable on condition that a record including the set of the designated license ID and the tenant ID is stored in the license information storage unit 232 and a condition that the value “status” of the record stored in the license information storage unit 232 is “unused (before use)”. On the other hand, in a case where at least one of the conditions is not satisfied, the license is determined to be unusable. In a case where the processes of Step S211 and after are performed asynchronously with respect to the processes of Steps S201-S204, whether the set of the designated CE_ID, the CE password, and the tenant ID is included in the tenant information storage unit 231 may also be a condition for determining the usability of the license.

Then, the license management unit 223 returns (transmits) a determination result to the Web UI unit 131 (Step S215). In a case where the determination result indicates that the license is unusable, the processes hereafter are canceled. In a case where the determination result indicates that the license is usable, the Web UI unit 131 designates the tenant ID, the license ID, the device serial ID, the start date and transmits a license use start request including the designations to the license management unit 223 (Step S216). It is to be noted that the device serial ID is obtained from the device 10 by the Web UI unit 131. Further, the date of the current day may be automatically selected as the start date by the license management unit 223. Alternatively, a specific date may be selected by the customer engineer via the license use start screen.

Then, the license management unit 223 executes a process for validating the license corresponding to the license ID designated by the license use start request (Step S217). Specifically, the license management unit 223 stores the device serial ID designated by the license use start request in the license information storage unit 232. More specifically, the device serial ID designated by the license use start request is stored in the record of the license information storage unit 232 that includes the set of the tenant ID and the license ID designated by the license use start request. Further, license management unit 223 updates the value of the status of the record from “unused” to “currently used”. Further, the license management unit 223 stores corresponding values in the items “start date” and “end date” of the record. The designated start date is stored in the item “start date”. For example, the date of a predetermined period after the start date may be stored as the “end date”. Prior to the execution of Step S217, it may be determined whether the tenant ID and the device serial ID received in Step S216 are stored in association with each other in the device information storage unit 233. Thus, in a case where the tenant ID and the device serial ID are not stored in association with each other, the execution of Step S217 is canceled.

Then, in a case of using the device cooperation service where a request to cooperate with a device cooperation service corresponding to a designated device serial ID and a license ID is received from the device application “A” 132 or the device application “B” 133, the license management unit 223 may permit the use of the license corresponding to the license ID if the item “status” of the record corresponding to the license ID is “currently used” and the designated device serial ID is included in the item “device serial ID” of the record corresponding to the license ID. That is, the use of the license becomes possible by the process of Step S217. In order for a license to be used, it is a premise that the “use of service” is permitted for the role of the logged-in user requesting the device cooperation service. In this embodiment, the use of the license may be permitted for the user administrator or the regular user.

In the above-described embodiment, the customer engineer can use his/her CE account to perform, for example, the device registration or the start of use of a license. Thus, in order to perform operations such as registering a device (device registration) or starting the use of a license (license start operation), the customer engineer does not need to ask for the administrator ID and the administrator password from the user administrator. Further, the customer engineer does not need to request the user administrator to input the administrator ID and the administrator password.

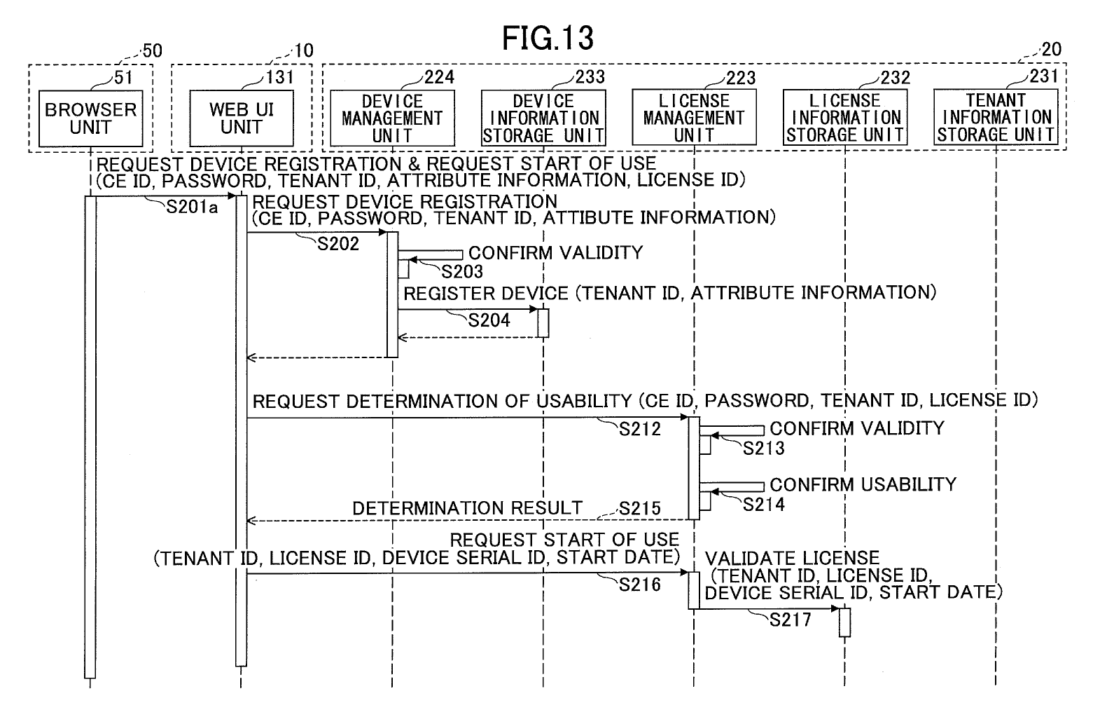

It is to be noted that input items that are displayed on the device registration screen and the license use start screen may be combined to be displayed on a single screen (hereinafter also referred to as “device activation screen”). Thus, the items can be input at a single time on the device activation screen to execute the processes of Steps S201-S204 and Steps S212-S217. An example of a sequence (procedure) of processes executed in the case of using the device activation screen is described below with reference to FIG. 13.

FIG. 13 is a sequence diagram for describing a second example of a sequence of processes executed when the use of a license is started. In FIG. 13, like reference numerals (step numbers) are used for like steps of FIG. 10 and are not further explained. At the start of the sequence of FIG. 10, it is assumed that the device activation screen is displayed on the CE terminal 50 by the browser unit 51.

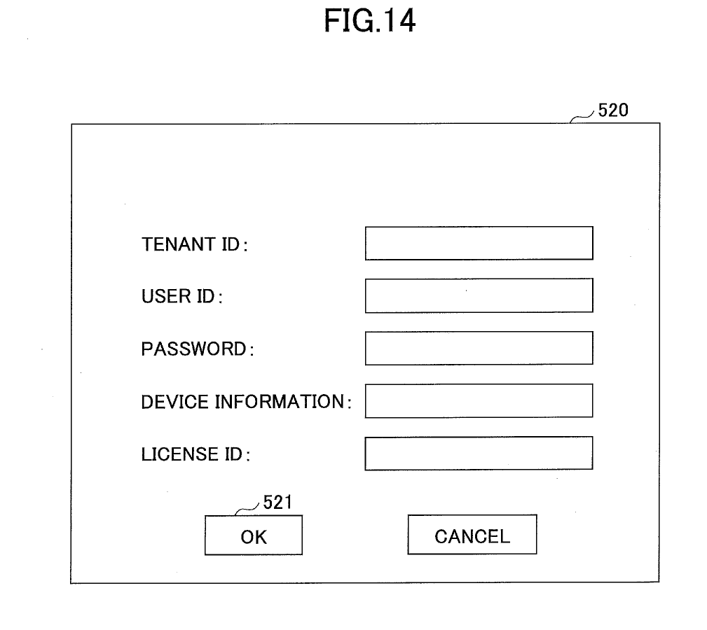

FIG. 14 is a schematic diagram illustrating an example where the device activation screen is displayed. In FIG. 14, a device activation screen 520 includes an input space for inputting a tenant ID, a user ID, a password, device information, and a license ID.

In a case where the customer engineer inputs, for example, a tenant ID, a CE_ID, a CE password, device information, and a license ID to the device activation screen and depresses an OK button 521, Step S201a is executed. In Step S201a, the browser unit 51 transmits a device registration request and a license use start request including designations of the input information (tenant ID, user ID, password, device information, and license ID) to the Web UI unit 131. For example, a character string indicating the installed location of the device 10 may be included in the input device information. In this case, the device serial ID, the device name, and the device type may also be added according to the device 10.

Then, similar processes performed in Steps S202-S204 of FIG. 10 are performed. After Step S204 is completed, a response to the device registration request is transmitted (returned) to the Web UI unit 131. Then, the processes of Step S212 and after are performed in accordance with the returned response.

In this embodiment, device registration and license management are permitted for the user administrator. Therefore, the processes of FIG. 10 or FIG. 13 can also be executed by using the administrator ID and the administrator password instead of the CE_ID and the CE password. On the other hand, the processes of FIG. 10 and FIG. 13 would fail if a regular user uses his/her user ID and password.

Next, a sequence (procedure) of processes executed according to a user management operation by the user administrator is described.

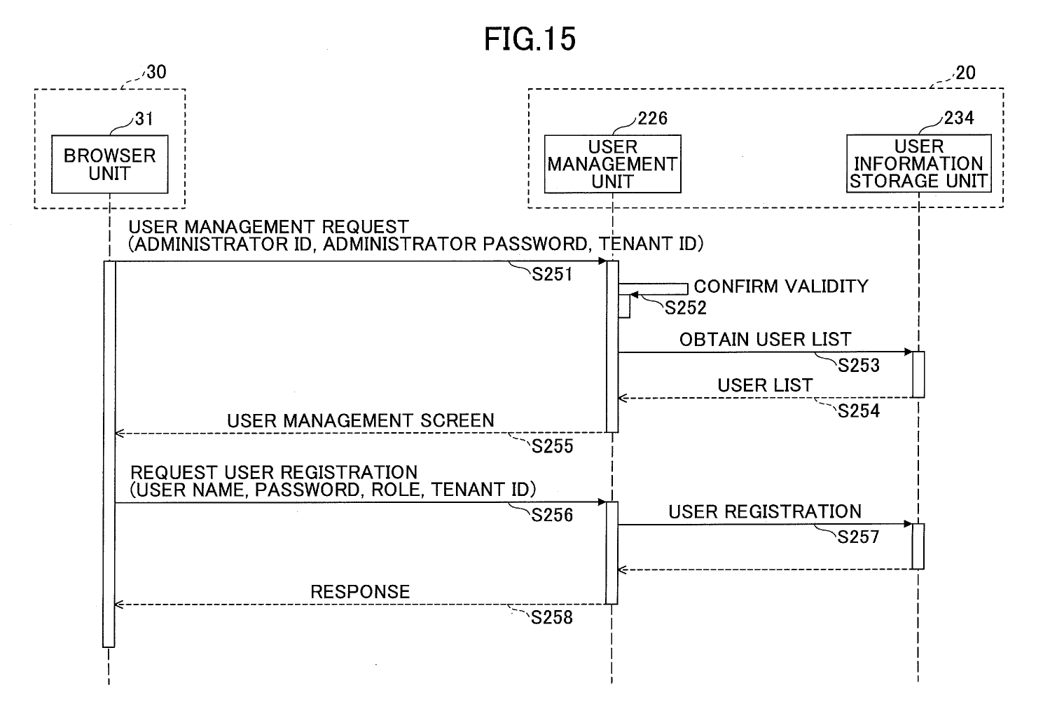

FIG. 15 is a sequence diagram for describing a sequence of processes executed for adding a regular user. At the start of the sequence of FIG. 15, it is assumed that a menu screen is displayed on the administrator terminal 30 by the browser unit 31. The menu screen includes menu items for receiving input requests of various operations.

In a case where the user administrator selects a menu item pertaining to user management, the browser unit 31 transmits a user management request to the user management unit 226 of the service providing device 20 (Step S251). The user management request includes, for example, designations of the administrator ID, the administrator password, and the tenant ID. The administrator ID, the administrator password, and the tenant ID may be input to a log-in screen that is displayed according to a selected menu item.

Then, the user management unit 226 confirms the validity of the user management request (Step S252). More specifically, the user management unit 226 determines whether the user information storage unit 234 is stored with a record including a set of the administrator ID, the administrator password, and the tenant ID designated in the user management request. In a case where the user information storage unit 234 has not stored the record including the set of the designated information, the processes hereafter are canceled. In a case where the user information storage unit 234 has stored the record including the set of the designated information, the user management unit 226 determines whether user registration is permitted to the “role” of the record by referring to the authority information storage unit 235 (FIG. 11).

In a case where user management is not permitted for the role of the user, the processes hereafter are canceled. Thus, supposing a case where the user management request is received from a customer engineer having the role “CE” or a regular user having the role “regular user”, the processes hereafter are canceled. In a case where license management is permitted for the role “user administrator”, the user management unit 226 obtains a list of records that includes the designated tenant ID of the user management request from the user information storage unit 234 (Steps S253, S254). The list including user information registered in the obtained record is also hereinafter referred to as “user list”. Then, the user management unit 226 returns (transmits) information of a user management screen including the user list to the browser unit 31 (Step S255). The browser unit 31 displays the user management screen.

The user management screen displays, for example, each user information included in the user list. Each user information may be displayed in a selectable or editable state. Further, the user management screen includes areas for receiving input of a new user's user ID and password. In this embodiment, user information pertaining to the customer engineer may be excluded from the user list displayed in the user management screen. Thus, for example, the user management unit 226 may exclude a user information corresponding to the role “CE” from the user management screen. Alternatively, the user management unit 226 may exclude user information including a user ID having a specific symbol (e.g., asterisk (*), exclamation mark (!)) from the user list. In this case, the user ID of the customer engineer may be generated to include the specific symbol. By excluding the user information of the customer engineer from the display items displayed on the user management screen, confusion due to user information of a non-existant user (unexpected by the user administrator) displayed on the user management screen can be prevented. Further, supposing a case where the user administrator is aware of the user information of the customer engineer, inadvertent updating, deletion or the like of the user information of the customer engineer can be prevented.

Then, the user administrator inputs, for example, the new user's user name, password, and role in the user management screen to instruct the input information to be registered. When the instruction to register the input user information is input, the browser unit 31 transmits a user registration request to the user management unit 226 (Step S256). The user registration request includes, for example, designations of a user name, a password, a role, and a tenant ID. The tenant ID received in Step S251 is inherited by the transmitted tenant ID defined by the user management screen. Further, the transmitted role may be the designation “administrator” or “regular user” but not the designation “CE”. For example, “administrator” and “regular user” may be displayed as items to be selected from the user management screen. Further, in a case where the role is input as a character string, the user management unit 226 that has received the user registration request can confirm a value of the role, and deny user registration in a case where the value of the role is “CE”. Further, for example, in a case where there is an overlap of user IDs with respect to the same tenant ID or a case where an unusable letter is included in the user ID, the user registration request may be denied.

In a case where the user registration request is denied, the user management unit 226 associates the received tenant ID, user ID, password, and role and stores the associated information in the user information storage unit 234 (Step S257). Then, the user management unit 226 returns (transmits) a response indicating, for example, acceptance/denial of the user registration request to the browser unit 31 (Step S258).

Because the updating of user information or deletion of user information can be understood by the above description, further explanation thereof is omitted.

Next, utilization of information managed by the tenant storage unit 231, the license information storage unit 232, and the device information storage unit 233 (hereinafter also referred to as “management information”) is described.

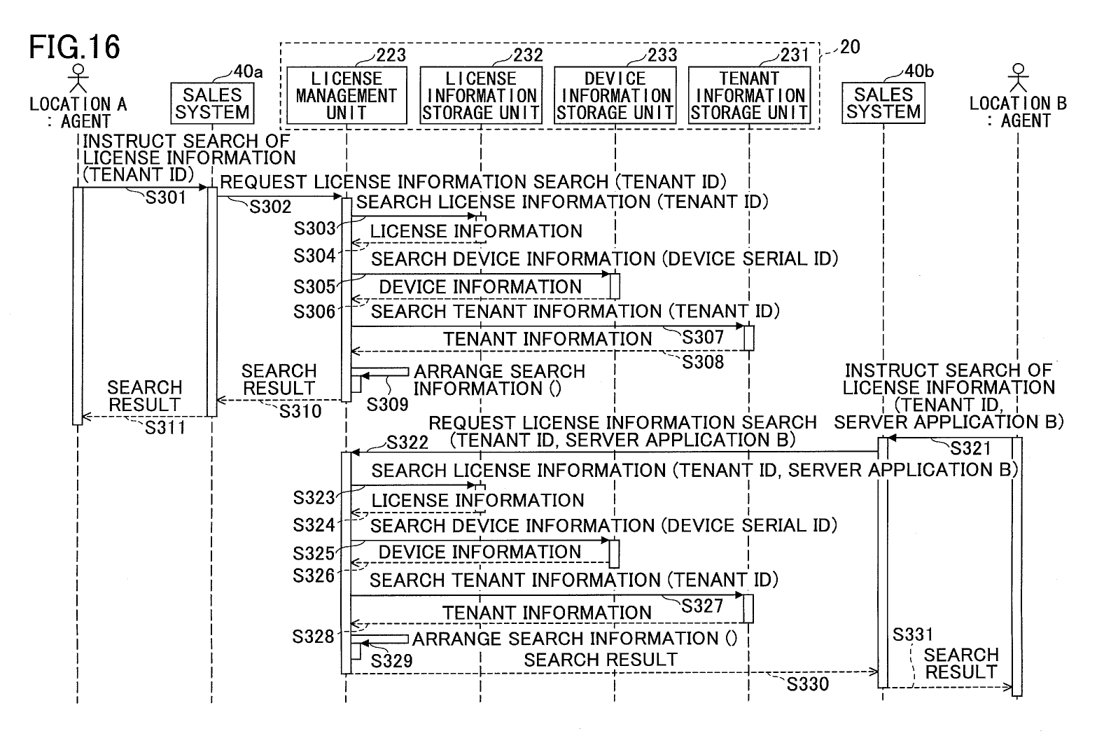

FIG. 16 is a sequence diagram for describing a sequence of processes executed when utilizing the management information. It is assumed that an agent assigned to a given sales location (hereinafter also referred to as “location A”) desires to confirm license information pertaining to a specific tenant (hereinafter referred to as “target tenant”).

In this case, the agent designates a tenant ID of the target tenant and inputs an instruction to search for license information to a sales system 40a of the location A (Step S301). The sales system 40a transmits a license information search request to the license management unit 223 of the service providing device 20 (Step S302). The license information search request includes a designation of the tenant ID. In a case where association information having tenant names (e.g., company names) associated with tenant IDs are managed by the sales system 40a, the tenant name may be input to the sales system 40a instead of the tenant ID in Step S301. Thus, the sales system 40a may transmit a search request including a designation of a tenant ID corresponding to the input tenant name.

The license management unit 223 searches for a record including the tenant ID (license information) in the license information storage unit 232 and obtains the record including the license information (Steps S303, S304). Then, the license management unit 223 searches for a record including a device serial ID corresponding to the obtained license information (device information) in the device information storage unit 233 and obtains the record including the device information (Steps S305, S306). In a case where multiple license information are found in the search of Step S304, device information corresponding to each of the multiple license information is searched.

Then, the license management unit 223 searches for a record including the tenant ID (tenant information) in the tenant information storage unit 231 and obtains the record including the tenant information (Steps S307, S308).

Then, the license management unit 223 arranges (formats) the information obtained in Steps S303-S308 and outputs the arranged information as a license information search result (Step S309). For example, the license management unit 223 may associate each license information with the device information corresponding to the device serial ID included the license information. Then, the license management unit 223 returns (transmits) the license information search result to the sales system 40a (Step S310). Then, the sales system 40a outputs the license information search result (Step S311).

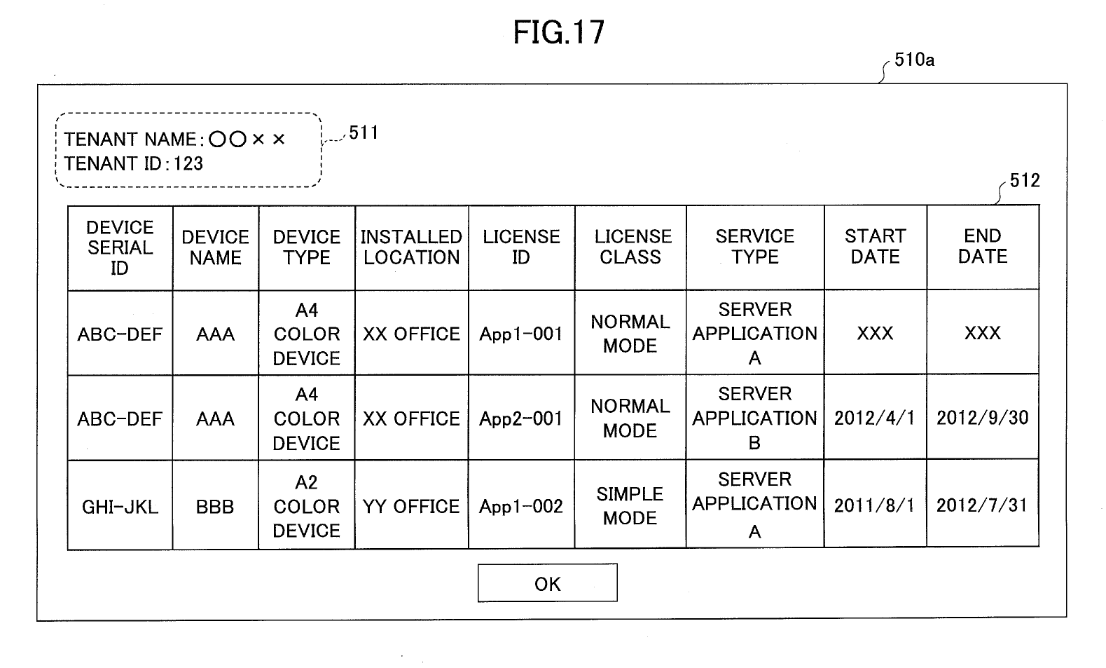

FIG. 17 is a schematic diagram for describing a first example of the license information search result. FIG. 17 illustrates a license information display screen 510a that displays license information as a search result. The license information display screen 510a includes, for example, a tenant information display area 511 and a license information display area 512.

The tenant information obtained in the search of Steps S307 and S308 is displayed in the tenant information display area 511. The license information obtained in the search of Steps S303 and S304 is displayed in the license information display area 512. The license information is displayed in a manner associated with device information obtained in the search of Steps S305 and S306.

Thereby, the agent can easily confirm license information pertaining to the specific tenant by referring to the license information display screen 510a.

Then, it is assumed that an agent assigned to a given sales location (hereinafter also referred to as “location B”) desires to confirm a license list of a specific service type (e.g., server application B 212”) pertaining to a specific tenant (hereinafter referred to as “target tenant”).

In this case, the agent designates a tenant ID of the target tenant and a service type (in this example, server application B) and inputs an instruction to search for license information to a sales system 40b of the location B (Step S321). The sales system 40b transmits a license information search request to the license management unit 223 of the service providing device 20 (Step S322). The license information search request includes a designation of the tenant ID and the service type. In a case where association information having tenant names (e.g., company names) associated with tenant IDs are managed by the sales system 40b, the tenant name may be input to the sales system 40b instead of the tenant ID in Step S321. Thus, the sales system 40b may transmit a search request including a designation of a tenant ID corresponding to the input tenant name.

The license management unit 223 searches for a record including both the tenant ID and the service type (license information) in the license information storage unit 232 and obtains the record including the license information (Steps S323, S324). Then, the license management unit 223 searches for a record including a device serial ID corresponding to the obtained license information (device information) in the device information storage unit 233 and obtains the record including the device information (Steps S325, S326). In a case where multiple license information are found in the search of Step S324, device information corresponding to each of the multiple license information is searched.

Then, the license management unit 223 searches for a record including the tenant ID (tenant information) in the tenant information storage unit 231 and obtains the record including the tenant information (Steps S327, S328).

Then, the license management unit 223 arranges (formats) the information obtained in Steps S323-S328 and outputs the arranged information as a license information search result (Step S329). For example, the license management unit 223 may associate each license information with the device information corresponding to the device serial ID included the license information. Then, the license management unit 223 returns (transmits) the license information search result to the sales system 40b (Step S330). Then, the sales system 40b outputs the license information search result (Step S331).

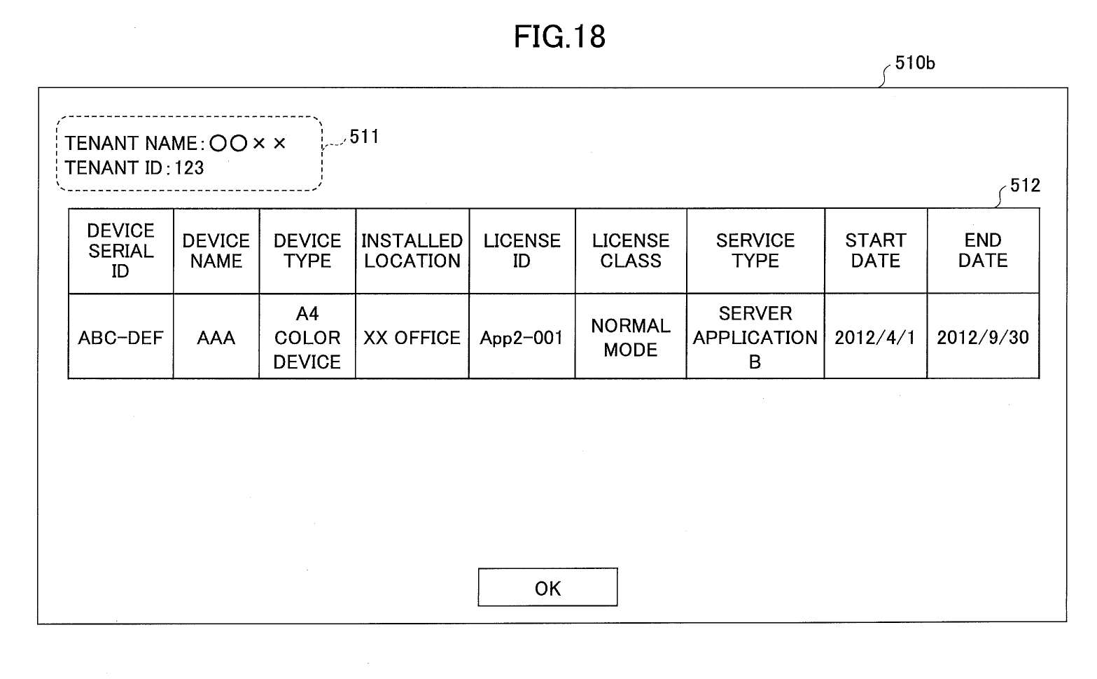

FIG. 18 is a schematic diagram for describing a second example of the license information search result. In FIG. 18, like parts are noted with like reference numerals as those of FIG. 17 and are not further explained. FIG. 18 illustrates a license information display screen 510b that displays license information as a search result.

Thereby, the agent can easily confirm license information pertaining to the specific tenant and the specific service type by referring to the license information display screen 510b.

Hence, with the above-described embodiment of the present invention, a tenant ID is assigned to each organization and a license ID is managed in association with the tenant ID. Therefore, the status of the use of a service (license) can be managed in units of organizations.

As a result, classification of the contents of services (licenses) in units of organizations can be facilitated. Further, confirmation of the statuses of services (licenses) in units of organization can be facilitated.

Further, billing costs (charging costs) corresponding to the use of each license can be easily managed in units of organizations.

Further, with the above-described embodiment, the customer engineer does not require the presence of the user administrator because a customer account dedicated for the customer engineer is generated. Thus, the customer engineer can perform operations such as the device registration operation and license use start operation on behalf of the user administrator. As a result, a part of the workload of performing various operations required for starting the use of the device cooperation service can be reduced for the user.

Although the tenant ID is stored in the license information storage unit 232 in the above-described embodiment, the tenant ID need not be stored in the license information storage unit 232 as long as the uniqueness of the device serial ID can be ensured among tenants. This is because the associated relationships between service IDs and the tenant IDs can be identified by way of the device serial ID.

One or all of the units including such as the tenant information storage unit 231, the license information storage unit 232, the device information storage unit 233, the user information storage unit 234, and the authority information storage unit 235 may have an external storage unit connected to the service providing device 20 via a network.

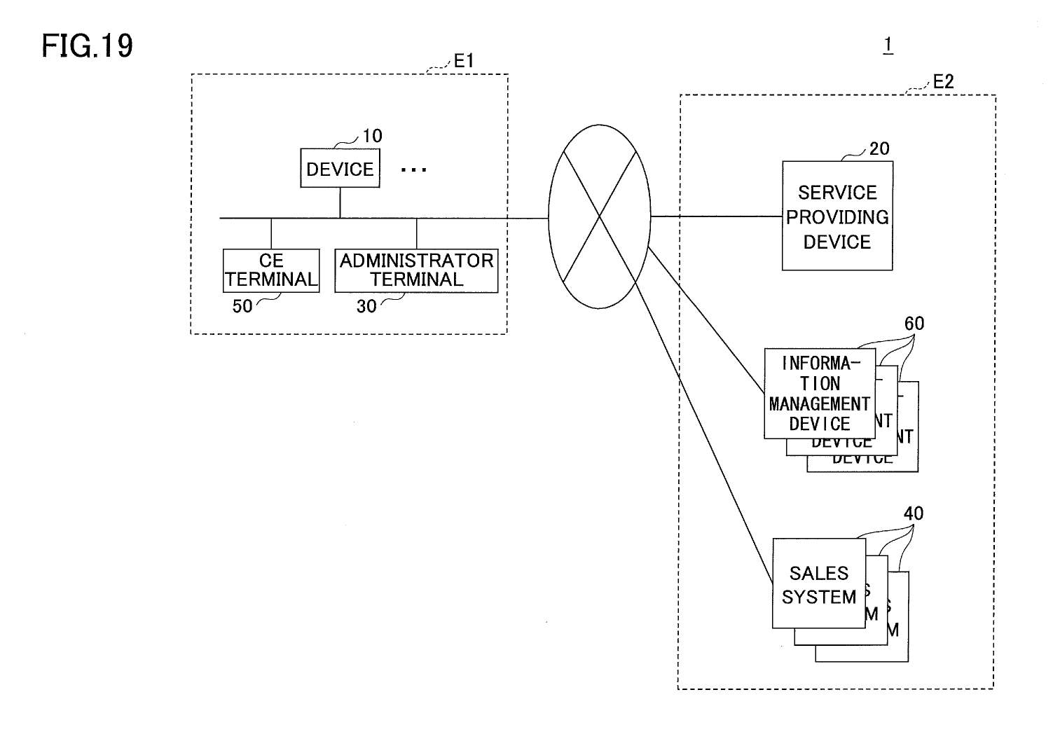

FIG. 19 is a schematic diagram illustrating a second example of a configuration of an information management system 1 according to an embodiment of the present invention. In FIG. 19, like parts/components are denoted with like reference numerals as those of FIG. 1 and are not further explained.

The information management system 1 of FIG. 19 further includes one or more information management devices 60. The information management device 60 is communicably connected to the service providing device 20 via a network. The information management device 60 is an example of an external storage device. That is, the information management device 60 includes a part of or all of the storage units illustrated in FIG. 4. In a case where there are multiple information management devices 60, Each of the storage unit of FIG. 4 may be separately assigned to one or more of the multiple information management devices 60. Alternatively, a storage unit included in each of the multiple information management devices 60 may be separate from each other.

By having each of the storage units of FIG. 4 managed by an external storage device that is separate from the service providing device 20, information stored in each of the storage units can be uniformly managed (consolidated) even in a case where service providing devices 20 are installed in respective areas (e.g., in each country).

In a case where the information management system 1 has the configuration illustrated in FIG. 19, the processes of storing information in each of the storage units as illustrated in, for example, FIGS. 4, 10, 13, and 16 are performed by transmitting the information to the information management device 60 including a storage unit corresponding to each of the storage units. Further, the processes of obtaining information from each of the storage units are performed by receiving the information from the information management device 60 including a storage unit corresponding to each of the storage units.

For example, in Step S104 of FIG. 6, the license management unit 223 associates the tenant ID of the target tenant with the user information pertaining to the user administrator and transmits the associated information to the information management device 60 including a corresponding storage unit via a network. Thereby, the information management device 60 associates the received tenant ID and the user information and stores the associated information in the user information storage unit 234.

Further, in Step S106 of FIG. 6, the license management unit 223 associates the tenant ID of the target tenant and CE account and transmits the associated information to the information management device 60 including the user information storage unit 234 via a network. Thereby, the information management device 60 associates the received tenant ID with the CE account and stores the associated CE account in the user information storage unit 234.

Further, in Step S203 of FIG. 10, the device management unit 224 transmits the tenant ID included in the received device registration request to the information management device including the user information storage unit 234 via a network. Thereby, the information management device 60 returns (transmits) a response including the user ID (user administrator ID or CE_ID) associated with the tenant ID. In a case where the user administrator ID or the CE_ID included in the returned response matches the user ID included in the device registration request, the device management unit 224 performs the processes executed on and after the step of confirming the role corresponding to the user ID in the device registration request.

Further, in Step S217 of FIG. 10, the license management unit 223 associates the license ID included in the license use start request and the device serial ID and transmits the associated information to the information management device 60 including the license information storage unit 232 via a network.

In the above-described embodiments, the service providing apparatus 20 is an example of an information management apparatus or an information management system. The license management unit 223, is an example of a user information generation unit, a return unit, and a license information transmitting unit. The administrator ID is an example of a first user identification information. The CE_ID is an example of a second user identification information. The tenant ID is an example of an organization identification information. The device serial ID is an example of device identification information. The license ID is an example of license identification information.

The present invention is not limited to the specifically disclosed embodiments, and variations and modifications may be made without departing from the scope of the present invention.

The present application is based on and claims the benefit of priority Japanese Priority Application Nos. 2013-222894 and 2014-215342 filed on Oct. 28, 2013 and Oct. 22, 2014, respectively, with the Japanese Patent Office, the entire contents of which are hereby incorporated by reference.

What is claimed is:

1. An information management system comprising:
a user information generation unit that generates a first user identification information of a first user and a second user identification information of a second user having a second authority different from a first authority of the first user and stores organization identification information in association with the first and second user identification information in response to a request to register an organization that uses a service provided via a network;
a device information storage unit, upon receiving the organization identification information, device identification information identifying a device connected to the network, and the first or the second user identification information, stores the device identification information in association with the organization identification information in a case where the received first or the second user identification information is stored in association with the organization identification information; and
a license information storage unit, upon receiving the device identification information and license identification information identifying a license corresponding to the service, stores the license identification information in association with the device identification information.

2. The information management system as claimed in claim 1, further comprising:
a return unit that transmits the first user identification information in response to the request to register the organization.

3. The information management system as claimed in claim 1, further comprising:
a user management unit that adds a third user identification information of a user having a third authority that is different from the second authority, to the user information storage unit, deletes the third user identification information from the user information storage unit, or updates the third user identification information in the user information storage unit in response to a request based on the first user identification information.

4. The information management system as claimed in claim 3,
wherein the user management unit is configured to deny the addition of the third user identification information, the deletion of the third user identification information, or the updating of the third user identification information in response to a request based on the second user identification information.

5. An information management system comprising:
a user information generation unit that generates a first user identification information of a first user and a second user identification information of a second user having a second authority different from a first authority of the first user and transmits organization identification information in association with the first and second user identification information to a first external storage device via a network, in response to a request to register an organization that uses a service provided via the network;
a device information storage unit, upon receiving the organization identification information, device identification information identifying a device connected to the network, and the first or the second user identification information, transmits the received organization identification information to the first external storage device and stores the device identification information in association with the organization identification information in a case where the received first or the second user identification information matches the first user identification information or the second user identification information that is stored in association with the organization identification information returned from the first external storage device; and
a license information storage unit, upon receiving the device identification information and license identification information identifying a license corresponding to the service, transmits the license identification information in association with the device identification information to a second external storage device via the network.

6. An information management method comprising the steps of:
generating a first user identification information of a first user and a second user identification information of a second user having a second authority different from a first authority of the first user, and storing organization identification information in association with the first and second user identification information in response to a request to register an organization that uses a service provided via a network;
storing, upon receiving the organization identification information, device identification information identifying a device connected to the network, and the first or the second user identification information, the device identification information in association with the organization identification information in a case where the received first or the second user identification information is stored in association with the organization identification information; and
storing, upon receiving the device identification information and license identification information identifying a license corresponding to the service, the license identification information in association with the device identification information.
